(19) United States
(12) Patent Application Publication
(10) Pub. No.: US 2026/0332877 A1
(43) Pub. Date: Oct. 22, 2026

(54) IMAGING APPARATUS

(71) Applicant: Panasonic Intellectual Property Management Co., Ltd., Osaka (JP)

(72) Inventors: Tatsunori JINNO, Osaka (JP); Shinichi YAMAMOTO, Osaka (JP)

(73) Assignee: Panasonic Intellectual Property Management Co., Ltd., Osaka (JP)

(21) Appl. No.: 19/645,200

(22) Filed: Apr. 12, 2026

(30) Foreign Application Priority Data
Apr. 17, 2025 (JP) 2025-068203

(51) Int. Cl. H04N 23/611; G06V 10/764; H04N 23/62; H04N 23/667; H04N 25/47

(52) U.S. Cl. CPC H04N 23/611; G06V 10/764; H04N 23/62; H04N 23/667; H04N 25/47

(57) ABSTRACT

An imaging apparatus includes an image sensor that captures a subject image to generate image data, and a controller that has a plurality of detection modes to be applied to the image data generated by the image sensor. The plurality of detection modes respectively perform image recognition processing that detects positions of subjects of mutually different types in an image indicated by the image data. The controller identifies a type of a subject in the image based on the image data. The controller switches, based on an identification result, a detection mode to be applied to the image data among the plurality of detection modes to perform the image recognition processing.

### TECHNICAL FIELD

The present disclosure relates to an imaging apparatus.

### BACKGROUND ART

JP 2021-132369 A describes an image processing apparatus including storage means that stores a plurality of dictionary data sets for respectively detecting a plurality of different subjects from an image, and detection means for detecting a subject. The detection means detects, for each frame of a plurality of frames of images obtained by imaging means, a subject corresponding to a subset of the plurality of dictionary data sets by using the subset of the plurality of dictionary data sets. The image processing apparatus switches the dictionary data used by the detection means in the plurality of frames according to a detection result of the subject by the detection means. JP 2021-132369 A states that the image processing apparatus can detect a plurality of types of subjects and can perform stable tracking of the subject.

### SUMMARY

The present disclosure provides an imaging apparatus capable of accurately detecting a subject.

An imaging apparatus according to one aspect of the present disclosure includes an image sensor that captures a subject image to generate image data, and a controller that has a plurality of detection modes to be applied to the image data generated by the image sensor. The plurality of detection modes respectively perform image recognition processing that detects positions of subjects of mutually different types in an image indicated by the image data. The controller identifies a type of a subject in the image based on the image data. The controller switches, based on an identification result, a detection mode to be applied to the image data among the plurality of detection modes to perform the image recognition processing.

The imaging apparatus according to the present disclosure can accurately detect a subject.

### BRIEF DESCRIPTION OF DRAWINGS

FIG. 1 is a block diagram illustrating a configuration example of a digital camera according to a first embodiment;

FIG. 2 is a diagram illustrating an overview of a flow of operations of the digital camera according to the first embodiment;

FIG. 3 is a flowchart illustrating an operation of the digital camera according to the first embodiment;

FIG. 4 is a flowchart for explaining a detection mode determination processing according to the first embodiment;

FIG. 5 is a diagram illustrating an example of an invalidation setting screen according to the first embodiment;

FIG. 6 is a table for explaining an operation of the digital camera according to the first embodiment;

FIG. 7 is a flowchart illustrating an operation of the digital camera according to a second embodiment;

FIG. 8 is a flowchart for explaining a flag adjustment processing according to the second embodiment;

FIG. 9A is a table for explaining an operation of the digital camera according to the second embodiment;

FIG. 9B is a table for explaining an operation of the digital camera according to the second embodiment;

FIG. 10 is a flowchart illustrating an operation of the digital camera according to a third embodiment;

FIG. 11 is a diagram illustrating an example of a priority setting screen according to the third embodiment;

FIG. 12 is a flowchart for explaining a detection mode determination processing according to the third embodiment;

FIG. 13A is a diagram for explaining a priority function according to the third embodiment;

FIG. 13B is a diagram for explaining a priority function according to the third embodiment;

FIG. 14 is a flowchart for explaining a flag adjustment processing according to the third embodiment;

FIG. 15 is a table for explaining an operation of the digital camera according to the third embodiment;

FIG. 16 is a block diagram illustrating a configuration example of a digital camera according to a fourth embodiment;

FIG. 17 is a flowchart illustrating an operation of the digital camera according to the fourth embodiment.

### DETAILED DESCRIPTION

Embodiments will now be explained with reference to drawings as appropriate. However, descriptions more in detail than necessary may be omitted. Note that the accompanying drawings and the following description are provided to facilitate those skilled in the art to fully understand the present disclosure, and the accompanying drawings and the following description are not intended to limit the subject matter defined in the claims in any way.

### 1. First Embodiment

### 1-1. Configuration

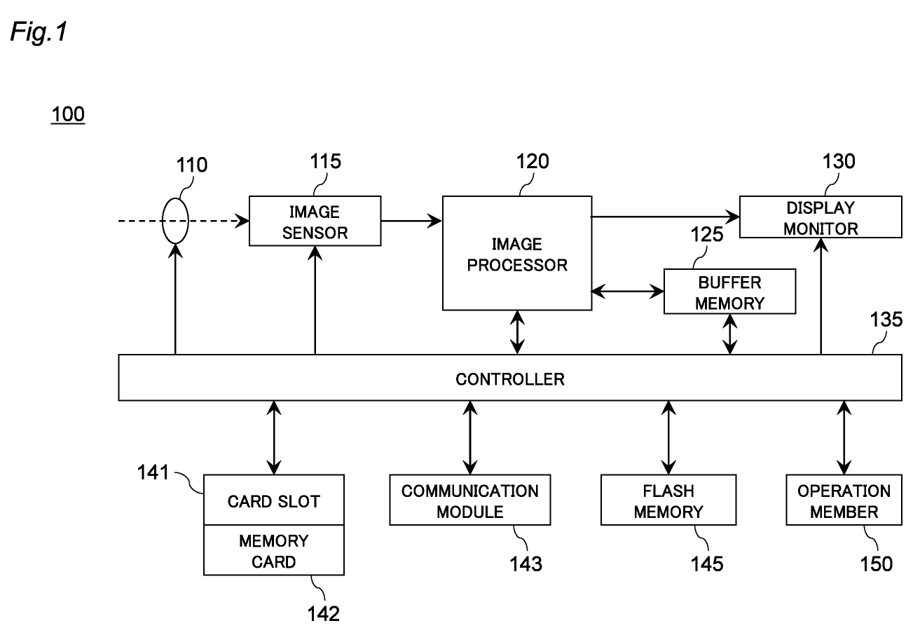

FIG. 1 is a block diagram illustrating a configuration example of a digital camera 100 according to a first embodiment of the present disclosure. The digital camera 100 generates image data by capturing a subject image. The image data generated by the digital camera 100 includes moving image data and still image data.

The digital camera 100 forms a subject image on an image sensor 115 through an optical system 110, and generates original image data (RAW data) by capturing the subject image. The image processor 120 generates image data by performing various types of processing on the RAW data generated by the image sensor 115. The controller 135 records the image data generated by the image processor 120 in a flash memory 145 or a memory card 142 inserted into a card slot 141. In addition, the controller 135 can display (reproduce) the image data recorded in the flash memory 145 or the memory card 142 on a display monitor 130, in accordance with a user operation on the operation member 150.

The optical system 110 includes a focus lens, a zoom lens, an optical image stabilization (OIS) lens, an aperture, and a shutter, for example. Various lenses included in the optical system 110 may include any number of lenses or any number of lens groups.

The image sensor 115 generates RAW data by capturing the subject image formed through the optical system 110. The image sensor 115 generates image data of a new frame at a predetermined frame rate (e.g., 30 frames/sec.). The timing of RAW data generation and the operations of the electronic shutter in the image sensor 115 are controlled by the controller 135.

The image processor 120 generates image data by performing various types of processing on the RAW data output from the image sensor 115. The image processor 120 also generates an image to be displayed on the display monitor 130, by performing various types of processing on the image data read from the memory card 142. Examples of the various types of processing include, but are not limited to, white balance correction, gamma correction, YC conversion processing, electronic zoom processing, compression processing, decompression processing, and image processing that uses a lookup table (LUT). The image processor 120 may be configured as a hard-wired electronic circuit or a microcomputer using a program.

The display monitor 130 is a display device such as a liquid crystal display or an organic EL display capable of displaying information. The display monitor 130 displays, for example, an image that is based on the image data processed by the image processor 120. The display monitor 130 also displays a menu screen for allowing a user to check settings of the digital camera 100.

The controller 135 integrally controls the entire operations of the digital camera 100. The controller 135 may include a processor configured to implement a predetermined function by executing a program. The controller 135 may include a circuit such as a CPU, an MPU, or an FPGA, for example. The controller 135 may include an internal ROM, although not illustrated. The ROM stores various programs, such as an autofocus (AF) control program, to be executed by the controller 135. The controller 135 may include an internal RAM (not illustrated) that functions as a working area of the CPU.

A buffer memory 125 is a recording medium that functions as a working memory of the image processor 120 and the controller 135. The buffer memory 125 is implemented as a dynamic random access memory (DRAM), for example.

The memory card 142 is inserted removably into the card slot 141. The card slot 141 can connect to the memory card 142 electrically and mechanically. The memory card 142 is an external memory including an internalized recording element such as a flash memory. The memory card 142 can store data such as image data generated by the image processor 120.

The communication module 143 includes a communication circuit that performs wireless or wired communication in accordance with a communication standard. For example, the digital camera 100 can communicate, via the communication module 143, with a communication network such as the Internet and/or another device equipped with a Wi-Fi module. The digital camera 100 may communicate directly with another device via the communication module 143, or may communicate via an access point.

The operation member 150 collectively refers to user interfaces such as a hardware key and a software key of the digital camera 100, and receives a user operation. Examples of the operation member 150 include a button, a mode dial, a touch panel, and a switch. Upon receiving a user operation, the operation member 150 transmits an operation signal corresponding to the user operation to the controller 135. The operation by buttons or the like as described above is not limited to physical buttons. For example, the operation may be performed by displaying a virtual button on the display monitor 130 and receiving a touch operation via the touch panel 155.

The flash memory 145 is a non-volatile storage medium. The flash memory 145 can store various types of data such as image data. The flash memory 145 may store a subject identification model described later. The subject identification model stored in the flash memory 145 is, for example, loaded into a RAM in the controller 135 during use. The storage location of the subject identification model is not limited to these examples, and the subject identification model may be stored in a storage medium such as the buffer memory 125 or the memory card 142, or may be stored in an external server that is communicable via the communication module 143.

### 1-2. Operation

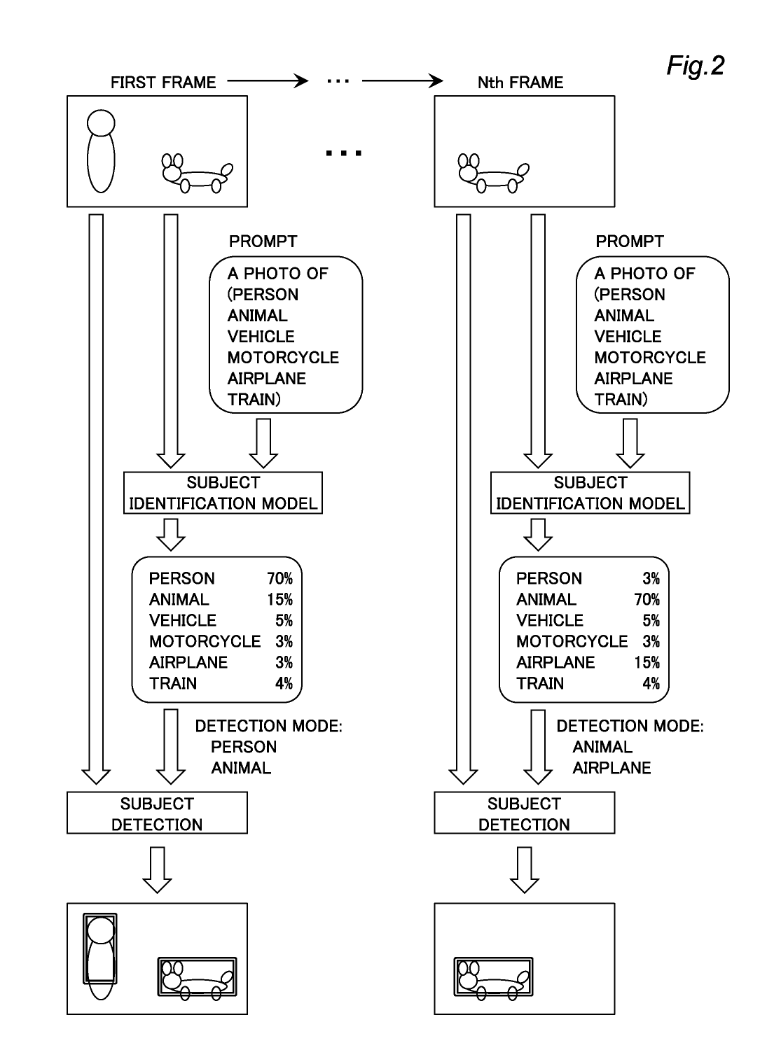

The operation of the digital camera 100 configured as described above will be described with reference to FIGS. 2-6.

FIG. 2 is a diagram illustrating an outline of an operation flow of the digital camera 100 in the present embodiment. A captured image acquired by the digital camera 100 is input to a subject identification model that is an example of a classifier.

The subject identification model is a trained model trained to receive input of image data and an instruction (prompt) and output data corresponding to the prompt. The subject identification model includes, for example, a neural network. The subject identification model includes, for example, a multimodal model such as contrastive language-image pre-training (CLIP). In the present embodiment, the image data input to the subject identification model is a captured image (frame) acquired by the digital camera 100. In the present embodiment, the prompt includes information instructing to define the subject type (category) and output the probability for each type. The subject types include, for example, types such as a person, an animal, a vehicle, a motorcycle, an airplane, and a train.

In the example of FIG. 2, the subject identification model that has received a first frame and a prompt outputs a probability that a subject belonging to each type is included in the first frame. In the example of FIG. 2, probabilities that subjects belonging to the types “person”, “animal”, “vehicle”, “motorcycle”, “airplane”, and “train” are included in the first frame are 70%, 15%, 5%, 3%, 3%, and 4%, respectively. In the example of FIG. 2, normalization is performed such that the sum of the probabilities for the respective types is 100%. In the example using CLIP, CLIP, which receives image data and a prompt, outputs a similarity between the image and each type designated by the prompt, and each similarity is converted into a probability by post-processing.

The digital camera 100 switches the detection mode based on the probability output from the subject identification model. For example, the digital camera 100 identifies the subject in the image by a person detection mode and an animal detection mode specialized to detect the types “person” and “animal” having the top two probabilities.

As described above, since the subject type is identified by the subject identification model and then switching is performed to the detection mode specialized for detecting the identified subject type, it is possible to detect the subject efficiently and accurately.

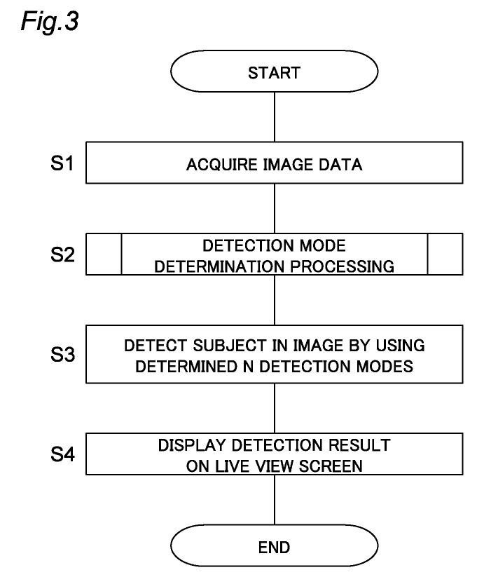

FIG. 3 is a flowchart illustrating an operation of the digital camera 100 in the present embodiment. The flow of FIG. 3 is repeatedly executed at a predetermined frame period, for example.

In FIG. 3, first, the controller 135 controls the imaging operation of the image sensor 115 to acquire image data (S1). For example, under the control of the controller 135, the image sensor 115 captures a subject image formed via the optical system 110 to generate RAW data, and outputs the RAW data to the image processor 120. The image processor 120 performs various types of processing on the RAW data to generate image data.

Then, the controller 135 executes detection mode determination processing S2 for switching the detection mode according to the image data acquired in step S1 (S2).

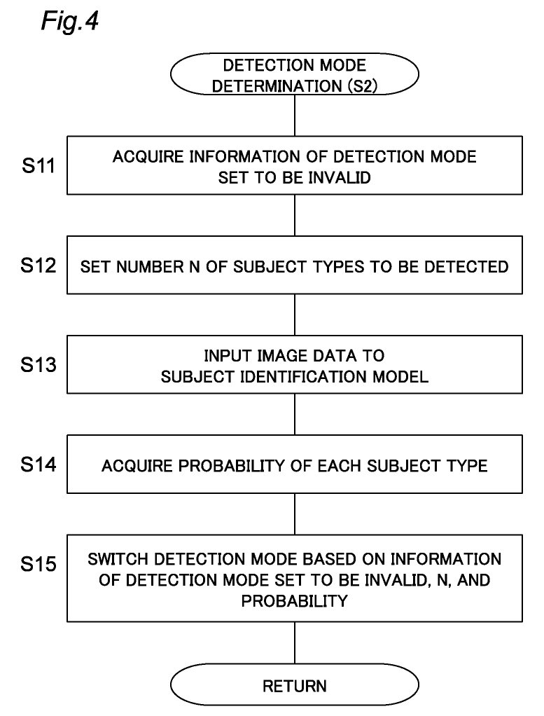

FIG. 4 is a flowchart for explaining the detection mode determination processing S2 illustrated in FIG. 3. In the detection mode determination processing S2 of FIG. 4, the controller 135 acquires information of the detection mode (invalid mode) set to be invalid (i.e., invalidated) (S11). The detection mode set to be invalid is excluded from the target of switching of the detection mode, and is not used for subject detection in step S3 described later.

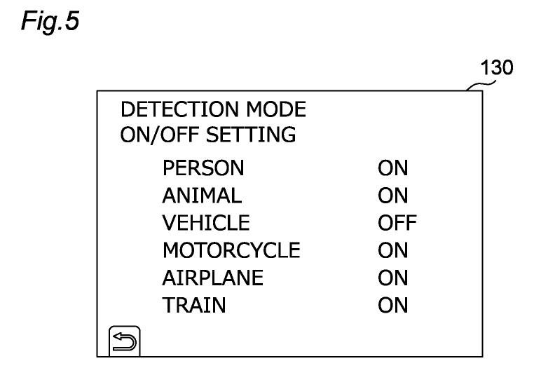

The invalid setting related to step S11 can be executed, for example, by the user inputting a user operation using the operation member 150. FIG. 5 is a diagram illustrating an invalid setting screen displayed on the display monitor 130 when such invalid setting is performed. In the example of FIG. 5, a vehicle detection mode for detecting a subject type “vehicle” is set to invalid (OFF).

Returning to FIG. 4, the controller 135 sets the number N of subject types to be detected (S12). N is an integer of 1 or more, and in the present embodiment, an example in which N = 2 will be described. N may be determined in advance, or may be settable by the user inputting a user operation using the operation member 150.

The controller 135 inputs the image data acquired in step S1 to the subject identification model (S13), and acquires the probability of each subject type output from the subject identification model according to the input (S14). In step S13, a prompt may be input to the subject identification model in addition to the image data.

The controller 135 switches the detection mode based on the information of the invalid mode acquired in step S11, N set in step S12, and the probability acquired in step S14 (S15). For example, the controller 135 determines N detection modes corresponding to N subject types having higher probabilities among the detection modes other than the detection mode set to be invalid.

Returning to FIG. 3, the controller 135 detects a subject in the image by using the N detection modes determined in step S15 (S3). The subject detection processing in step S3 may be referred to as image recognition processing.

The controller 135 displays the detection result of step S3 on the live view screen displayed on the display monitor 130 (S4). For example, a boundary line (bounding box) is displayed at the position of the detected subject. Alternatively, or in addition to this, the controller 135 may execute autofocus processing of adjusting the position of the focus lens so that the detected subject is focused.

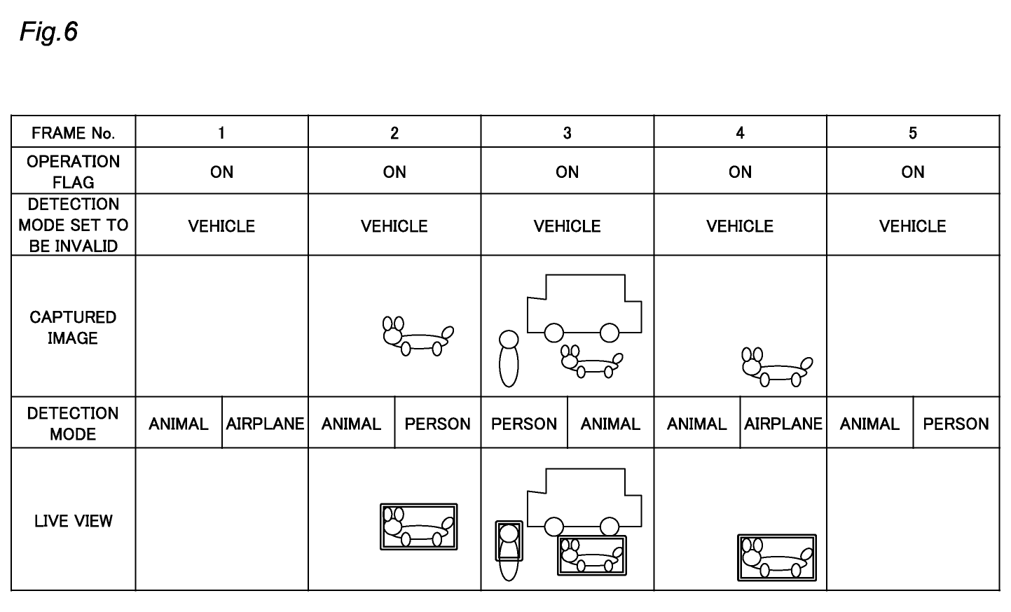

An example of output of the digital camera 100 in the present embodiment will be described with reference to FIG. 6. In the table of FIG. 6, the detection mode switched in the detection mode determination processing S2 according to the captured image (the fourth row in the table) acquired in step S1 is shown on the fifth row, and an example of the live view screen displayed in step S4 is shown on the sixth row. The first row of the table shows "the frame number", and the table of FIG. 6 shows the above-described items for each frame. The second row of the table indicates the state of the operation flag as to whether or not to perform the detection mode determination processing S2 on the frame. In the present embodiment, an example in which the operation flag is always ON and the detection mode determination processing S2 is executed every frame will be described. The third row of the table indicates a detection mode set to be invalid, and in the present embodiment, a vehicle detection mode for detecting a subject type “vehicle” is set to be invalid (OFF).

When the captured image is input to the subject identification model (S13), the controller 135 switches the detection mode based on the probability output from the subject identification model (S15). In the example of FIG. 6, an animal detection mode and an airplane detection mode are used in the first frame, and an animal detection mode and a person detection mode are used in the second frame. The subsequent frames are also as shown in the table of FIG. 6.

In the second frame of FIG. 6, a cat is shown in the captured image. The captured image of a cat is input to the subject identification model (S13). Since the subject types having the top two probabilities output from the subject identification model are “animal” and “person”, the animal detection mode and the person detection mode are adopted as shown on the fifth row. Among them, a cat is detected in the captured image in the animal detection mode (S3), and a bounding box as a detection result is displayed on the live view screen (S4).

The same applies to the other frames. For example, the person detection mode and the animal detection mode are adopted in the third frame, and the animal detection mode and the airplane detection mode are adopted in the fourth frame, based on the probabilities acquired in step S14.

As described above, by switching the detection mode based on the probabilities, it is possible to detect the subject efficiently and accurately.

### 1-3. Summary

As described above, the digital camera 100 according to the present embodiment includes the image sensor 115 and the controller 135. The image sensor 115 captures a subject image to generate image data. The controller 135 has a plurality of detection modes each of which is applied to the image data generated by the image sensor 115. The plurality of detection modes respectively perform image recognition processing that detects positions of subjects of mutually different types in an image indicated by the image data. The controller 135 identifies the type of the subject in the image based on the image data. The controller 135 switches the detection mode to be applied to the image data among the plurality of detection modes based on the identification result (S2) to perform the image recognition processing (S3).

The digital camera 100 according to the present embodiment can accurately detect a subject by switching the detection mode according to the subject in an image.

In the present embodiment, the image data may be moving image data including a plurality of frames sequentially captured by the image sensor 115 at a predetermined frame period. The controller 135 identifies the subject type in each frame, and switches the detection mode to be applied to the frame among the plurality of detection modes based on the identification result. The digital camera 100 according to the present embodiment can accurately detect the subject in each frame. As a result, the digital camera 100 can easily track the subject over a plurality of frames.

In the present embodiment, the digital camera 100 may further include an operation member 150 that is an example of a user interface. The operation member 150 receives an input of a user operation that invalidates at least one of the plurality of detection modes. The controller 135 excludes the at least one detection mode invalidated by the user operation from switching targets of the plurality of detection modes (S14). Since the number of targets for switching the detection mode is reduced, the digital camera 100 according to the present embodiment can efficiently detect a subject desired by the user.

In the present embodiment, the digital camera 100 may further include a subject identification model that is an example of a classifier. The subject identification model outputs, for each of a plurality of predetermined types of subjects, a probability that a subject of the type is included in the image. The controller 135 identifies the type of the subject in the image based on the probability for each type output by the subject identification model, and switches the detection mode to be applied to the image data among the plurality of detection modes based on the identification result. As a result, the digital camera 100 according to the present embodiment can easily detect the subject with high accuracy.

### 2. Second Embodiment

In a second embodiment, when each of the detection modes used in a certain frame detects a subject of the corresponding type, the digital camera 100 omits execution of the detection mode determination processing S2 for a certain period, thereby reducing the load on the controller 135.

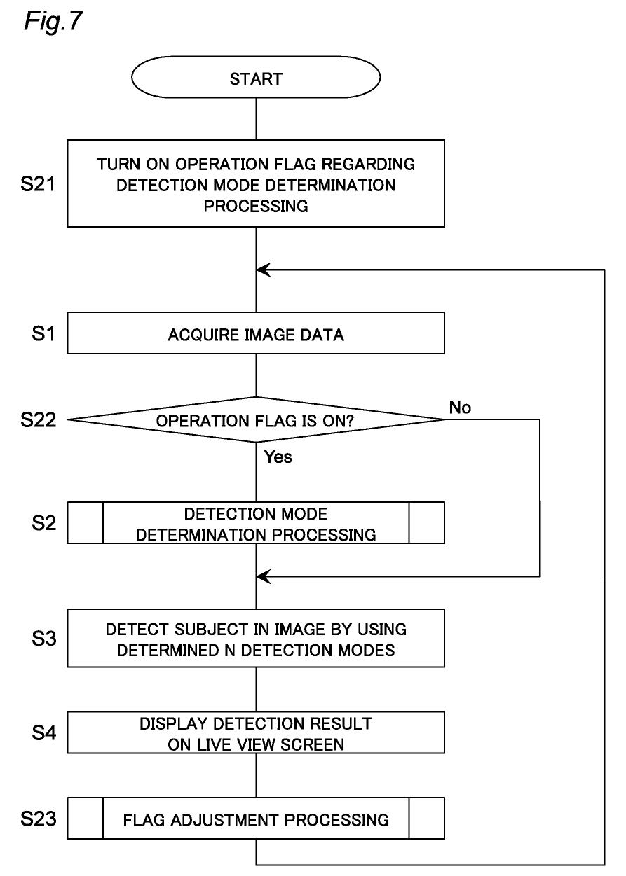

FIG. 7 is a flowchart illustrating an operation of the digital camera 100 in the second embodiment. In the flowchart of FIG. 7, processing similar to that in the first embodiment is denoted by the same reference numeral, and redundant description may be omitted.

In FIG. 7, first, the controller 135 turns on an operation flag as to whether or not to perform the detection mode determination processing S2 (S21). For example, the initial value of the operation flag is set to "1" corresponding to ON.

The controller 135 controls the imaging operation of the image sensor 115 to acquire image data (S1). The imaging operation is repeatedly executed at a predetermined frame period, for example.

The controller 135 determines whether or not the operation flag is ON (S22). The controller 135 executes the detection mode determination processing S2 when the operation flag is ON (Yes in S22), and does not execute the detection mode determination processing S2 when the operation flag is OFF (No in S22). The detection mode determination processing S2 is processing similar to that described in the first embodiment.

The controller 135 detects the subject in the image by the N detection modes determined in the detection mode determination processing S2 (S3), and displays the detection result on the live view screen (S4). When the detection mode determination processing S2 is executed for the current frame (Yes in S22), N detection modes determined for the current frame are used. When the detection mode determination processing S2 has not been executed for the current frame (No in S22), the N detection modes determined in the detection mode determination processing S2 executed most recently are used. That is, when the operation flag is OFF, the controller 135 stops identification of the type of the subject, and detects the position of the subject in the current frame using the most recently executed detection mode without switching the detection mode.

The controller 135 executes flag adjustment processing S23 for switching ON and OFF of the operation flag based on the detection result, and proceeds to acquisition of the next frame image.

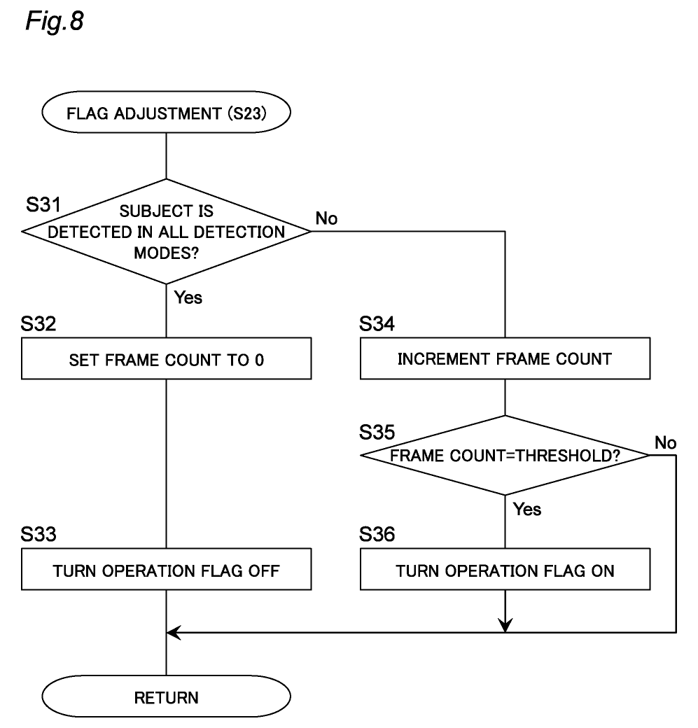

FIG. 8 is a flowchart for explaining the flag adjustment processing S23 illustrated in FIG. 7. In the flag adjustment processing S23 of FIG. 8, the controller 135 determines whether or not subjects are detected in all the N detection modes (S31). “Detection” of a subject in a certain detection mode means that the position of the subject of the type corresponding to the detection mode is specified as a result of executing the detection processing in the detection mode. When subjects are detected in all the detection modes (Yes in S31), the controller 135 sets the counter value (hereinafter, referred to as "frame count") to 0 (S32), and turns the operation flag OFF (S33).

In a case where subjects have been detected in all the detection modes adopted in a certain frame, it is normally expected that the same types of subjects are also detected in the next frame. This is because it is considered that the possibility that the subjects move greatly from the inside to the outside of the angle of view within one frame or that the subjects disappear is usually low. Therefore, when subjects are detected in all the detection modes, the operation flag is turned OFF, and identification of the type of the subject is stopped. As a result, in the next frame, the controller 135 detects the position of the subject by continuously using the most recently executed detection mode without switching the detection mode. Since the detection mode determination processing S2 for switching the detection mode is not executed, the calculation load of the controller 135 can be reduced.

On the other hand, in a case where no subject is detected continuously in any of the detection modes, it is reasonable to switch the detection mode so that a subject can be detected. Therefore, the controller 135 counts the number of frames in which no subject is detected in any of the detection modes as a frame count, and turns the operation flag ON to execute the detection mode determination processing S2 according to the frame count.

Specifically, when no subject is detected in any of the detection modes (No in S31), the controller 135 increments the frame count (S34), and determines whether or not the frame count has reached a predetermined threshold (S35). The predetermined threshold is an integer of 2 or more, for example, 3. When the frame count reaches the predetermined threshold (Yes in S35), the controller 135 turns the operation flag ON (S36) and ends the flag adjustment processing S23. When the frame count does not reach the predetermined threshold in step S35 (No in S35), the controller 135 ends the flag adjustment processing S23 without turning the operation flag ON.

The reason for providing a threshold of the frame count and not immediately turning the operation flag ON from the next frame when no subject is detected in any of the adopted detection modes (No in S31) is as follows. That is, even if a certain type of subject cannot be detected, when such a type of subject is detected in the near past, the probability that the type of subject can be detected again in the next frame is high to some extent. Therefore, the present embodiment is configured to continue searching for the subject of such a type for a certain period, rather than immediately changing the subject type of the detection target to another type. However, the present embodiment is not limited thereto, and when no subject is detected in any of the adopted detection modes (No in S31), the operation flag may be immediately turned ON from the next frame.

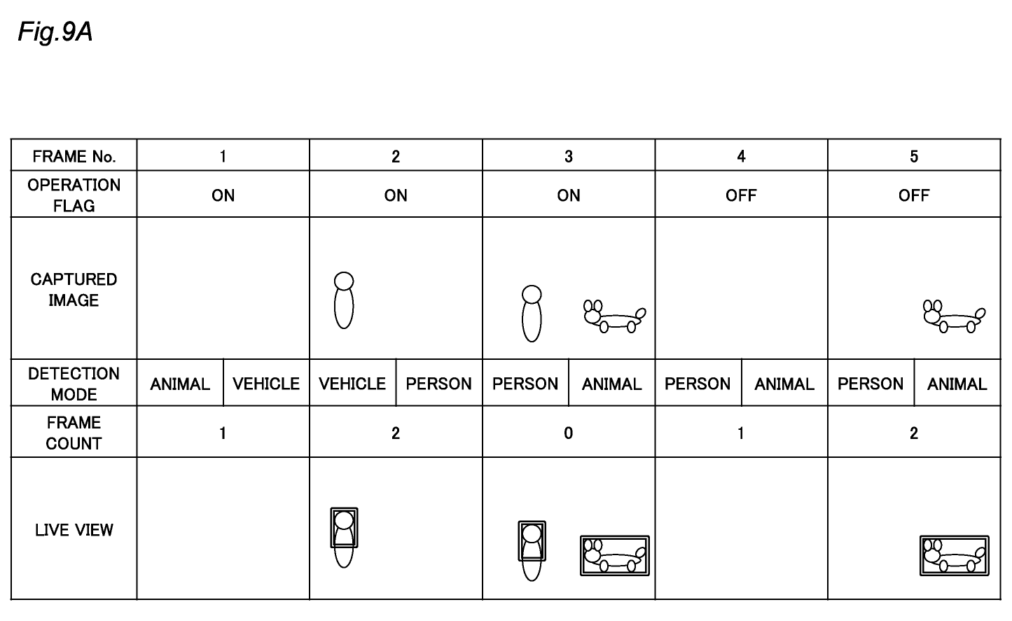

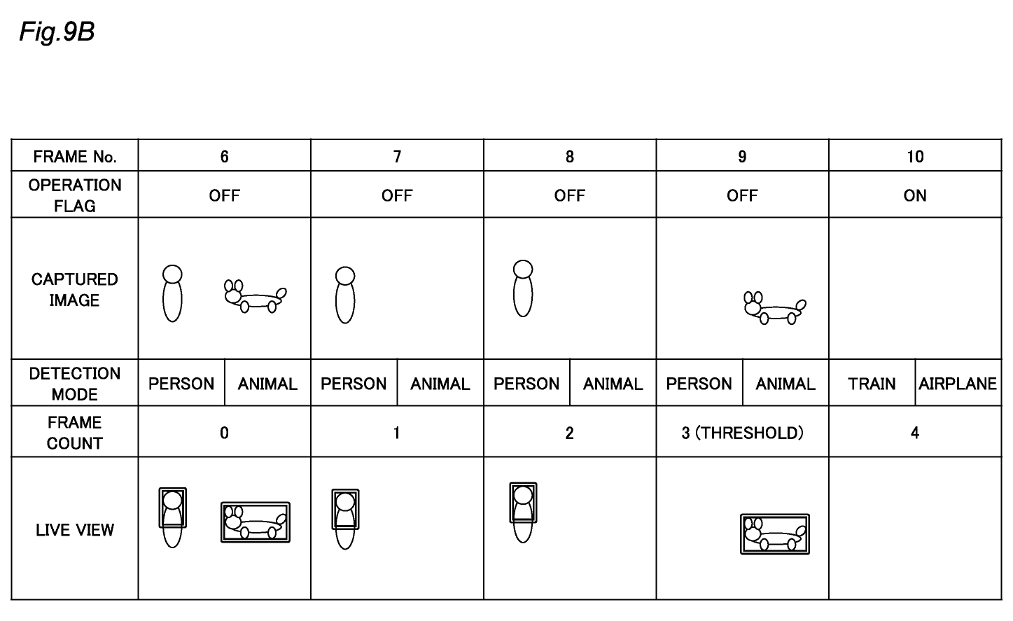

An example of output of the digital camera 100 in the present embodiment will be described with reference to FIGS. 9A and 9B. FIG. 9A illustrates exemplary output for the first to fifth frames, and FIG. 9B illustrates exemplary output for the sixth to tenth frames. The fifth row of the tables of FIGS. 9A and 9B describes the value of the frame count in each frame. The tables of FIGS. 9A and 9B illustrate an example in which a predetermined threshold in step S35 is 3.

In the third frame of FIG. 9A, the person detection mode and the animal detection mode are used, and the positions of a person and an animal are specified in the respective detection modes (Yes in S31). Therefore, the frame count is set to 0 (S32), and the operation flag is turned OFF (S33). In the table of FIG. 9A, the result that the operation flag is turned OFF in the third frame is reflected in the "operation flag" field in the second row of the fourth frame.

In the fourth frame, the controller 135 detects the positions of the subjects by continuously using the same detection modes (the person detection mode and the animal detection mode) as the previous detection modes, that is, those of the third frame, without switching the detection modes. In the fourth frame, since the positions of the subjects cannot be specified in both the person detection mode and the animal detection mode (No in S31 in FIG. 8), the frame count of the fourth frame is incremented to 1 from that of the third frame (S34). In the fifth frame, although the position of the cat can be specified in the animal detection mode, the position of the subject (person) cannot be specified in the person detection mode (No in S31 in FIG. 8), and thus the frame count is further incremented (S34).

As a result of the operation according to the flow of FIG. 8 as described above, in FIGS. 9A and 9B, the operation flag is turned OFF from the fourth frame to the ninth frame, and the detection modes are fixed to the person detection mode and the animal detection mode. In the ninth frame, as a result of the increment, the frame count has reached 3 that is the threshold (Yes in S35). Therefore, the controller 135 turns the operation flag ON (S36), and the detection mode is switched in the tenth frame to adopt the train detection mode and the airplane detection mode.

As described above, in the digital camera 100 according to the present embodiment, the image data is moving image data including a plurality of frames sequentially captured at a predetermined frame period by the image sensor 115. When the position of a subject of a specific type is detected in the image recognition processing in the detection mode applied to a specific frame as the identification result of the type of the subject (Yes in S31), the controller 135 stops identification of the type of the subject in the frame subsequent to the specific frame (S33), and performs the image recognition processing using the same detection mode as the detection mode applied to the specific frame. As described above, since identification of the type of the subject is stopped under a predetermined condition, it is possible to reduce the calculation load of the controller 135 while keeping the detection accuracy of the subject high.

In the present embodiment, when, while the identification of the type of the subject is stopped, in the image recognition processing using the detection mode same as that applied to the specific frame, the position of the subject of the specific type corresponding to the detection mode is not detected for a predetermined period (Yes in S35), the controller 135 cancels the stop of the identification of the type of the subject (S36), and switches the detection mode to be applied to the image data among the plurality of detection modes based on the identification result. As a result, the digital camera 100 according to the present embodiment can keep the detection accuracy of the subject high.

### 3. Third Embodiment

### 3-1. Outline of Operation

In a third embodiment, the digital camera 100 switches the detection mode so as to preferentially detect a subject of a preset type. The subject type to be prioritized is selected, for example, when the user inputs a user operation via the operation member 150.

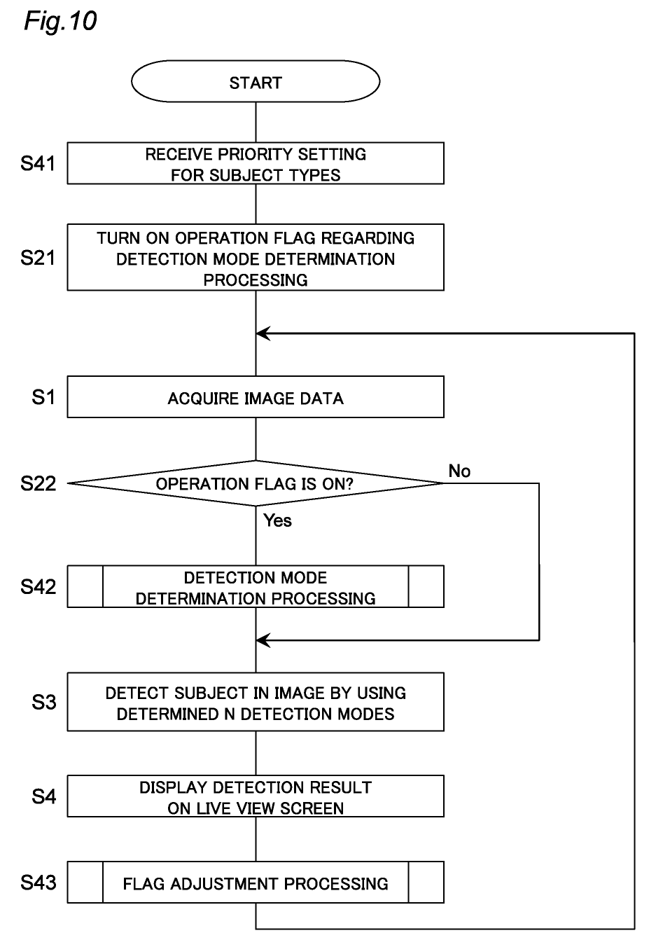

FIG. 10 is a flowchart illustrating an operation of the digital camera 100 in the third embodiment. In the flowchart of FIG. 10 and other flowcharts in the present embodiment, processing similar to that of the first or second embodiment is denoted by the same reference numeral, and redundant description may be omitted.

In FIG. 10, the controller 135 receives an input of a user operation to perform priority setting of the subject type via the operation member 150, for example (S41). In the present embodiment, priority setting of the subject type means that at least one type among a plurality of types is designated to be prioritized over the other types with respect to application of the detection mode.

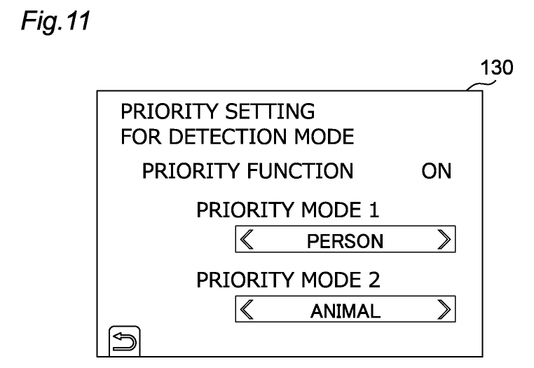

FIG. 11 is a diagram illustrating a priority setting screen displayed on the display monitor 130 when such priority setting is performed. For example, the user can perform priority setting by inputting a user operation via the operation member 150 while viewing the priority setting screen in FIG. 11. On the priority setting screen illustrated in FIG. 11, the priority function can be switched between ON and OFF. In addition, when the priority function is ON, it is possible to designate that a type corresponding to which of the detection modes is prioritized. In the example of FIG. 11, the priority function is set to ON, and priority is given to a person and an animal.

Returning to FIG. 10, the controller 135 turns on the operation flag as to whether or not to perform detection mode determination processing S42 (S21), and controls the imaging operation of the image sensor 115 to acquire image data (S1). The imaging operation is repeatedly executed at a predetermined frame period, for example.

The controller 135 determines whether or not the operation flag is ON (S22). When the operation flag is ON, the controller 135 executes the detection mode determination processing S42 to be described later, and when the operation flag is OFF, the controller 135 does not execute the detection mode determination processing S42.

The controller 135 detects a subject in the image by the N detection modes determined in the detection mode determination processing S42 (S3). The controller 135 displays the detection result of step S3 on the live view screen displayed on the display monitor 130 (S4). The controller 135 executes flag adjustment processing S43 for switching ON and OFF of the operation flag based on the detection result, and proceeds to acquisition of the next frame image.

### 3-2. Detection Mode Determination Processing

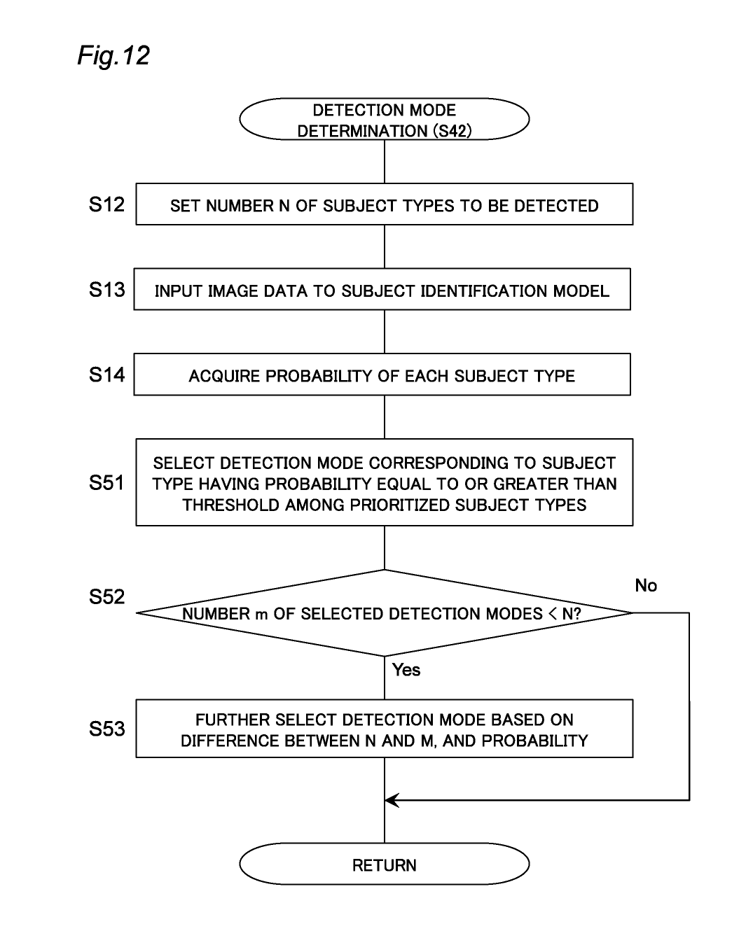

FIG. 12 is a flowchart for explaining the detection mode determination processing S42 illustrated in FIG. 10. In FIG. 12, the controller 135 sets the number N of subject types to be detected (S12), inputs the image data to the subject identification model (S13), and acquires the probability of each subject type output from the subject identification model (S14).

Next, the controller 135 selects a detection mode corresponding to a subject type having a probability equal to or greater than a predetermined threshold among the prioritized subject types (S51). The controller 135 determines whether or not the number m of the detection modes selected in step S51 is smaller than N set in step S12 (S52). When m ≥ N (No in S52), since a sufficient number of detection modes equal to N have been selected in step S51, the detection mode determination processing S42 in FIG. 12 ends.

When m < N (Yes in S52), the controller 135 further selects a detection mode based on the difference between N and m and the probability acquired in step S14 (S53). For example, the controller 135 selects (N-m) detection modes corresponding to (N-m) subject types having a higher probability acquired in step S14 among the detection modes other than the detection mode selected in step S51, and ends the detection mode determination processing S42 in FIG. 12.

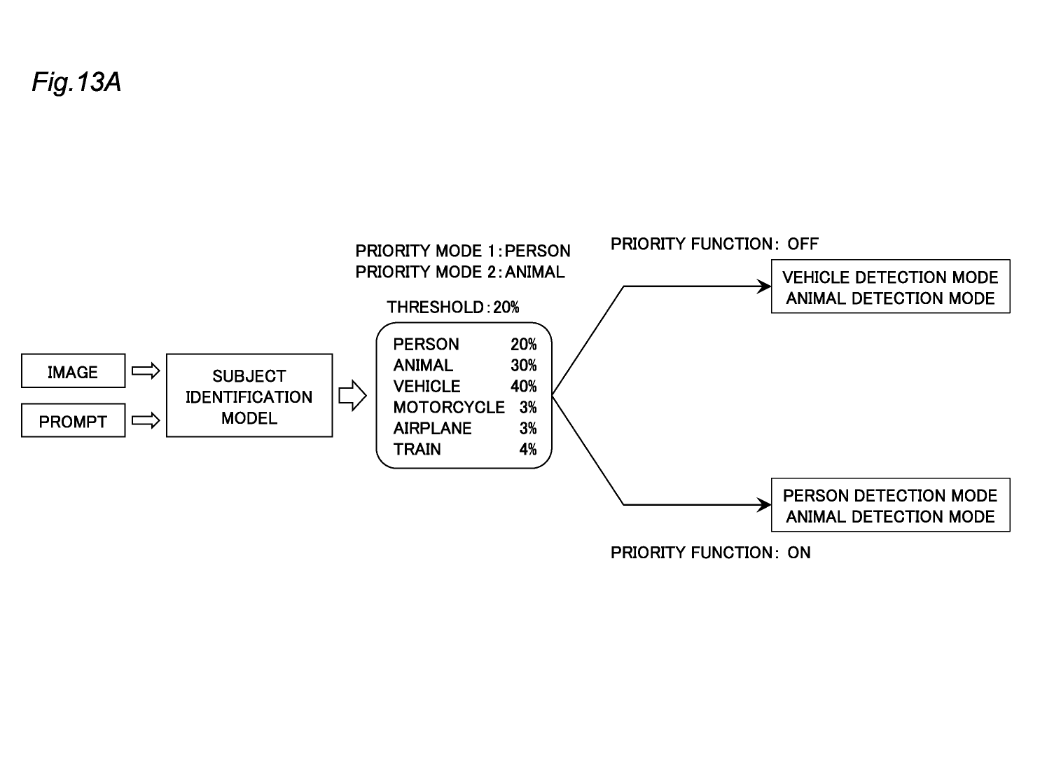

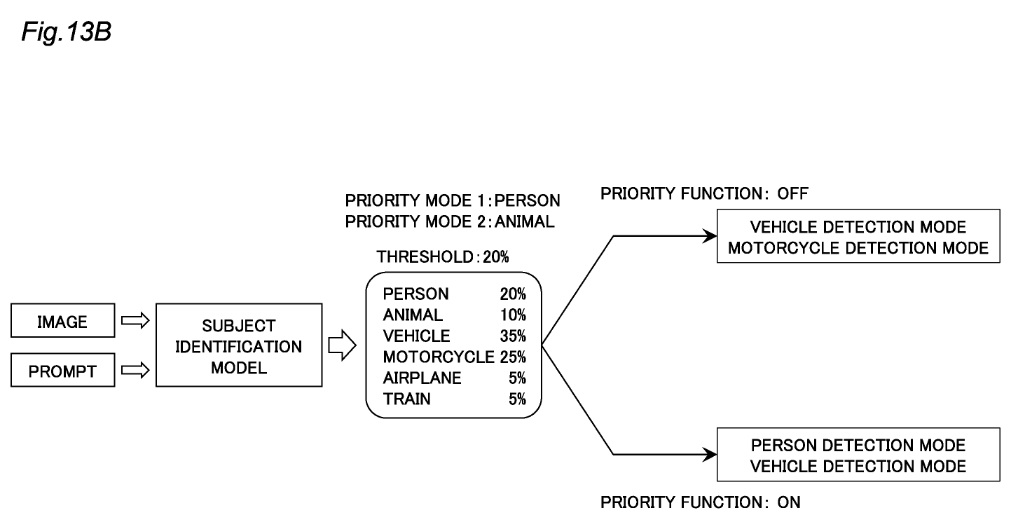

The detection mode selected according to the priority function will be described with reference to FIGS. 13A and 13B. In FIGS. 13A and 13B, an example in which the subject types "person" and "animal" are preferentially set, the probability threshold value in step S51 is 20%, and N = 2 will be described.

As illustrated in FIG. 13A, when the priority function is OFF as in the other embodiments, the controller 135 selects N (two) subject types “vehicle” and “animal” in the descending order of probabilities, and switches the detection mode to the vehicle detection mode and the animal detection mode corresponding thereto respectively.

On the other hand, when the priority function is ON as in the present embodiment, the controller 135 selects a detection mode corresponding to a subject type having a probability equal to or greater than a predetermined threshold among the prioritized subject types (S51). In the example of FIG. 13A, since the probabilities of "person" and "animal" that are the prioritized subject types are both 20% or more, the person detection mode and the animal detection mode are selected. Since the number m of selected modes is two and is equal to N (No in S52), the controller 135 ends the detection mode determination processing S42.

Another example will be described with reference to FIG. 13B. When the priority function is OFF, the controller 135 selects N (two) subject types “vehicle” and “motorcycle” in the descending order of probabilities, and switches the detection mode to the vehicle detection mode and the motorcycle detection mode corresponding thereto respectively.

When the priority function is ON in FIG. 13B, the controller 135 selects the person detection mode corresponding to "person" whose probability is 20% or more among the prioritized subject types (S51). In the example of FIG. 13B, since the probability of the prioritized "animal" is less than 20%, the animal detection mode is not selected in step S51. Since the number m of the selected modes is one and is smaller than N (Yes in S52), the controller 135 further selects (N-m) detection modes, that is, one detection mode (S53). Here, the vehicle detection mode corresponding to "vehicle" having the highest probability is selected.

As described above, the digital camera 100 according to the present embodiment can preferentially set the subject type of the detection target according to the user operation. As a result, it is possible to preferentially detect a subject of the type desired by the user. Furthermore, by selecting the subject type to be preferentially detected according to the photographing environment by the user, it is possible to improve the accuracy of subject detection in such a photographing environment.

### 3-3. Operation Flag Adjustment Processing

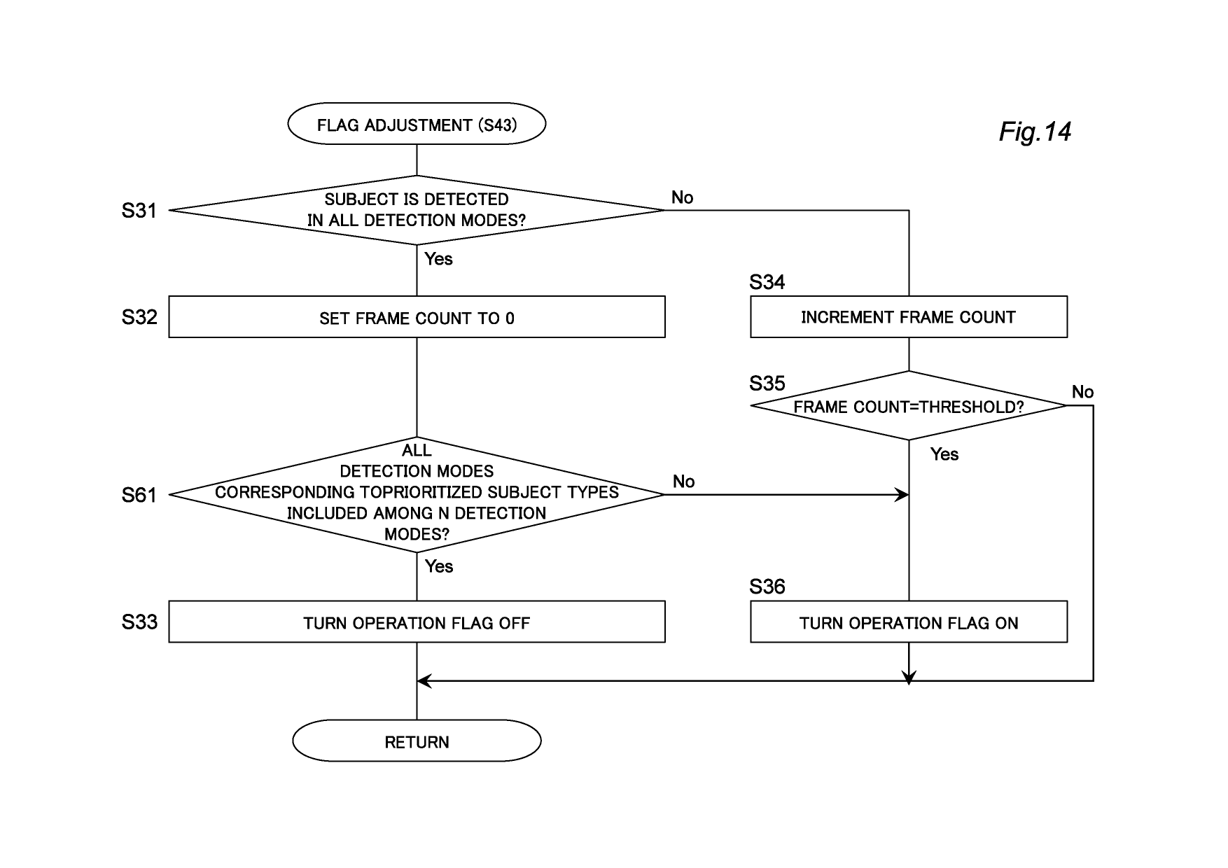

FIG. 14 is a flowchart for explaining the flag adjustment processing S43 illustrated in FIG. 10. Similarly to the second embodiment, the controller 135 determines whether or not a subject is detected in all the detection modes (S31), sets the frame count to 0 in the case of Yes (S32), and increments the frame count in the case of No (S34).

After step S34, when the frame count has reached the predetermined threshold (Yes in S35), the controller 135 turns the operation flag ON (S36) and ends the flag adjustment processing S43. When the frame count does not reach the predetermined threshold in step S35 (No in S35), the controller 135 ends the flag adjustment processing S43 without turning the operation flag ON.

On the other hand, after setting the frame count to 0 in step S32, the controller 135 determines whether or not all the detection modes (priority modes) corresponding to the subject types prioritized in step S41 are included among the N detection modes determined in the detection mode determination processing S42 (S61). When all the priority modes are included in the N detection modes (Yes in S61), the controller 135 turns the operation flag OFF (S33), and otherwise turns the operation flag ON (S36).

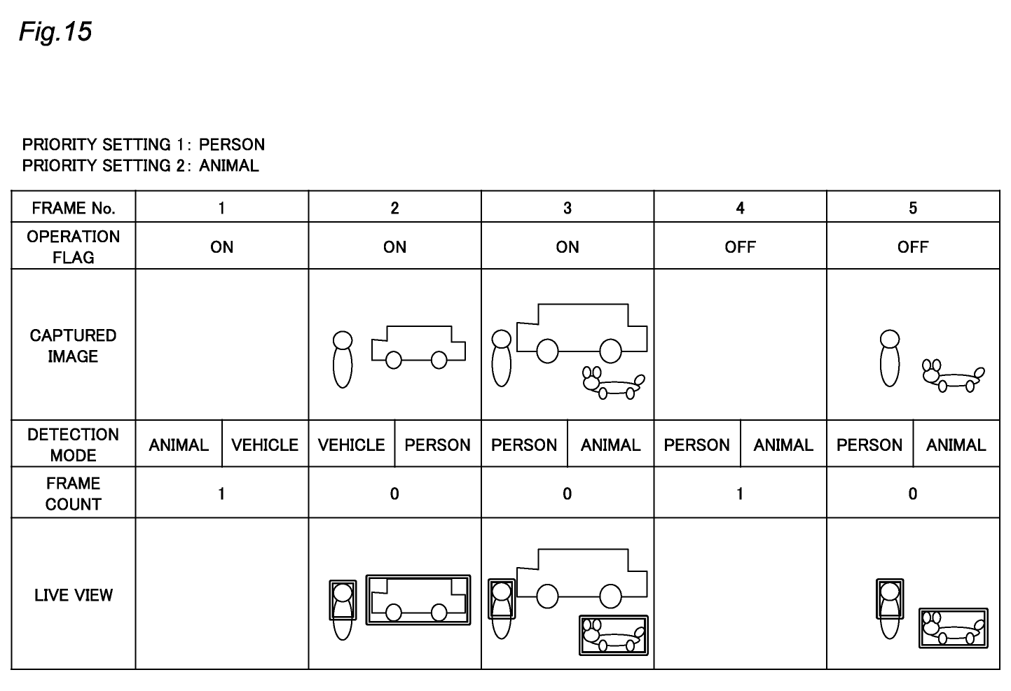

The flag adjustment processing S43 of the present embodiment as described above will be described with reference to FIG. 15. Here, an example in which the subject types “person” and “animal” are prioritized as in the above-described example will be described.

In the second frame of FIG. 15, the detection mode is switched to the vehicle detection mode and the person detection mode by the detection mode determination processing S42 according to the captured image, and as a result of detection in both modes (S3 in FIG. 10), the positions of both the vehicle and the person are specified. However, since the animal detection mode corresponding to the prioritized subject type “animal” is not included in the detection modes determined in the detection mode determination processing S42 (No in S61), the operation flag is not turned OFF and remains ON.

In the third frame of FIG. 15, since the positions of both the person and the animal are specified as a result of detection in the person detection mode and the animal detection mode (Yes in S61), the operation flag is turned OFF (S33). In the table of FIG. 15, the result that the operation flag is turned OFF in the third frame is reflected in the "operation flag" field in the second row of the fourth frame.

By the flag adjustment processing S43, it is possible to more preferentially detect a subject of the type designated by the user operation.

### 3-4. Summary

As described above, the digital camera 100 according to the present embodiment includes the operation member 150 that receives an input of a user operation that designates at least one type prioritized over other types among the plurality of types. When the probability of the at least one type is equal to or greater than the predetermined threshold value, the controller 135 switches the detection mode to be applied to the image data to a detection mode that detects a position of a subject of a type included in the at least one type (S51). When the probability of at least one type is less than the predetermined threshold, the controller 135 switches the detection mode to be applied to the image data to a detection mode that detects the position of a subject of the type having the highest probability among the plurality of types (S53).

As a result, it is possible to accurately detect a subject of the type designated by the user operation. Furthermore, since the user selects the subject type of the detection target according to the photographing environment, the accuracy of subject detection in such a photographing environment can be improved.

In the present embodiment, the image data may be moving image data including a plurality of frames sequentially captured by an imaging unit at a predetermined frame period. When a position of a subject of a specific type is detected in image recognition processing in a detection mode applied to a specific frame based on the identification result of the type of the subject (Yes in S31), and the detection mode is included in detection modes corresponding to at least one type designated by a user operation (Yes in S61), the controller 135 stops identifying the type of the subject in a frame subsequent to the specific frame (S33) and performs the image recognition processing using the detection mode same as that applied to the specific frame. As a result, a subject of a type designated by the user operation can be detected with higher priority.

### 4. Fourth Embodiment

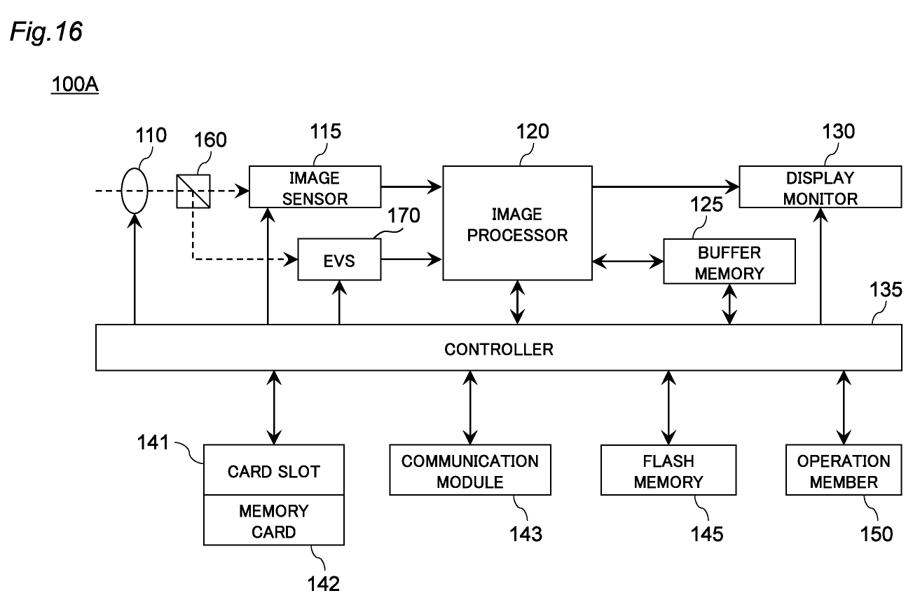

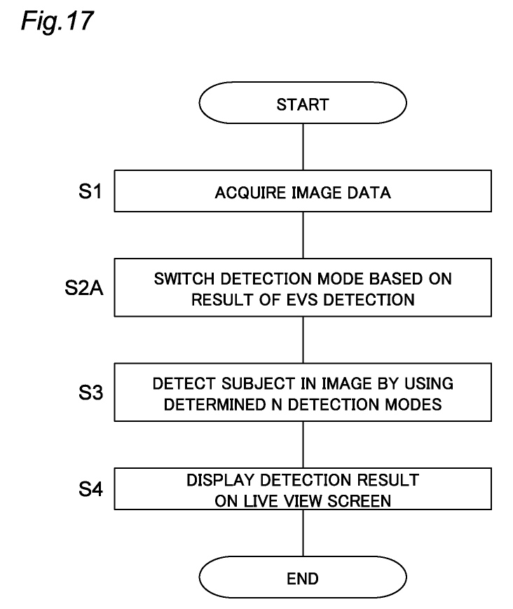

A fourth embodiment of the present disclosure will be described below with reference to FIGS. 16 and 17. In the above embodiment, an example has been described in which data regarding the type of a subject is output using the subject identification model, and the detection mode is switched based on the output. In the fourth embodiment, an example in which the detection mode is switched based on a detection result by an event sensor will be described. In the fourth embodiment, description of the same configuration and operation as those of the digital camera 100 according to the first embodiment may be omitted.

### 4-1. Configuration

FIG. 16 is a block diagram illustrating an exemplary configuration of a digital camera 100A according to the fourth embodiment. Compared with the digital camera 100 of the first embodiment, the digital camera 100A further includes a half mirror 160 and an event-based vision sensor (EVS) 170 that is an example of an event sensor.

The half mirror 160 is arranged such that, for example, incident light is made incident on both the image sensor 115 and the EVS 170 by transmission or reflection. The half mirror 160 may be arranged such that the transmitted light enters the image sensor 115 and the reflected light enters the EVS 170 as illustrated in FIG. 16, or conversely, may be arranged such that the reflected light enters the image sensor 115 and the transmitted light enters the EVS 170. The optical element disposed between the optical system 110 and the image sensor 115 is not limited to the half mirror 160, and may be another optical element such as a beam splitter as long as it can guide incident light to both the image sensor 115 and the EVS 170.

The EVS 170 is a sensor including a plurality of pixels, and each pixel detects a change in luminance of the incident light. The EVS 170 outputs information (event information) of the pixel in which a change in luminance is detected, together with coordinates of the pixel and time information. The event information of a certain pixel may be output asynchronously with another pixel.

The image processor 120 generates a luminance-changed image indicating a change in luminance in the field angle range based on the event information output from the EVS 170. The controller 135 generates a motion vector indicating the motion of the subject based on the luminance-changed image. Alternatively, the digital camera 100A may not generate a luminance-changed image, and the controller 135 may generate a motion vector based on the event information output from EVS 170. Furthermore, the controller 135 can detect the position of the subject based on the information of the coordinates included in the event information.

Since the EVS 170 can output event information at each pixel independently of the frame rate of the image sensor 115, the controller 135 can detect one or more events that occurred between frames of the captured image based on the output of the EVS 170.

### 4-2. Operation

FIG. 17 is a flowchart illustrating an operation of the digital camera 100A in the fourth embodiment. As compared with the flowchart of the first embodiment in FIG. 3, the digital camera 100A of the fourth embodiment executes step S2A instead of the detection mode determination processing S2.

In step S2A of FIG. 17, the controller 135 determines the detection mode according to the detection result of the EVS 170. As previously described, the controller 135 may detect one or more events between frames of the captured image based on the output of the EVS 170. In step S2A, the controller 135 generates a motion vector indicating the motion of the subject based on the event information output from the EVS 170.

The controller 135 estimates the subject type based on the generated motion vector. For example, the controller 135 estimates the subject type from the size, temporal change, and the like of the motion vector. For example, the controller 135 estimates the subject type from the size of the motion vector, the temporal change, and the like, based on a tendency that the motion of a person is generally larger than the motion of a dog, a small motion is generally included in the motion of a dog more than the motion of a person, and the like. The controller 135 switches the detection mode to be used to a detection mode corresponding to the estimated subject type.

The controller 135 detects a subject in the image in the detection mode determined in step S2A (S3). The controller 135 displays the detection result of step S3 on the live view screen (S4).

In order to accurately estimate the subject type when the digital camera 100A is not stationary, the controller 135 may remove the entire motion vector of the digital camera 100A from the primarily detected motion vector when generating the motion vector of the subject. For example, the controller 135 estimates the overall motion vector of the digital camera 100A based on the event information output from the EVS 170, and subtracts the overall motion vector from the primarily detected motion vector to generate the motion vector of the subject.

Furthermore, in order to accurately estimate the subject type in a case where there are a plurality of subjects, the controller 135 may acquire distance information indicating the distance between the digital camera 100A and each subject, and normalize the motion vector of each subject using the distance information. Such distance information may be obtained by image analysis of the captured image. Alternatively, the digital camera 100A may further include a distance sensor, and the controller 135 may acquire distance information from the distance sensor.

### 4-3. Summary

As described above, the digital camera 100A according to the present embodiment includes the EVS 170 that is an example of an event sensor that detects a change in luminance of the incident light. The controller 135 identifies the type of a subject based on a change in luminance detected by the event sensor, and switches the detection mode to be applied to the frame between a plurality of detection modes based on the identification result (S2A).

The digital camera 100A according to the present embodiment can accurately detect a subject by switching the detection mode according to the subject within the angle of view.

### 5. Other Embodiments

As described above, embodiments have been described as examples of the technology in the present disclosure. However, the technology of the present disclosure is not limited thereto, and can also be applied to embodiments in which changes, substitutions, additions, omissions, and the like are appropriately made. In addition, it is also possible to combine the components described in the above embodiments to form a new embodiment. Therefore, other embodiments will be exemplified below.

In the first embodiment, an example has been described in which the controller 135 determines N detection modes corresponding to N subject types with higher probabilities for each frame, in step S15 for switching the detection mode (see FIG. 4). However, the switching of the detection mode is not limited thereto. For example, when the probability for a certain subject type in a certain frame does not exceed a predetermined threshold (for example, 20%), in such a frame, the controller 135 may apply a detection mode different from the detection mode adopted in the previous frame. When the probability for a subject type does not exceed the predetermined threshold, which detection mode is adopted in the next frame, that is, the order of the detection modes, may be determined in advance. In this case, unless the probability for the subject type exceeds a predetermined threshold, the subject mode to be adopted is changed and rotated for each frame.

In the first embodiment, an example has been described in which the detection mode set to be invalid is excluded from the detection mode switching target (see S11 and S15 in FIG. 4). In particular, an example has been described in which the controller 135 determines the N detection modes corresponding to the N subject types having the higher probability among the detection modes other than the detection mode set to be invalid in step S15. However, the method of excluding the detection mode set to be invalid from the switching target of the detection mode is not limited thereto. For example, by not including the subject type corresponding to the detection mode set to be invalid in a prompt input to the subject identification model, the subject identification model may be set not to output the probability of such a subject type.

In the first embodiment, a subject identification model trained to receive input of image data and a prompt and output data corresponding to the prompt has been described. The subject identification model is not limited thereto. For example, the subject identification model may be a trained model subjected to machine learning so as to output information regarding the type of the subject in the image indicated by the learning image data when the learning image data is input. In this case, the controller 135 can identify the type of the subject by inputting the image data to such a trained model and acquiring information regarding the type of the subject from the trained model.

The concept of the present disclosure is not limited to the digital camera described in the above embodiments, and may also be implemented by an electronic device having an imaging function, such as a tablet terminal or a smartphone.

### Example of Aspects

Hereinafter, various aspects according to the present disclosure will be listed.

Aspect 1 according to the present disclosure provides an imaging apparatus including:
an image sensor that captures a subject image to generate image data; and
a controller that has a plurality of detection modes to be applied to the image data generated by the image sensor, wherein
the plurality of detection modes respectively perform image recognition processing that detects positions of subjects of mutually different types in an image indicated by the image data, and wherein
the controller:
identifies a type of a subject in the image based on the image data; and
switches, based on an identification result, a detection mode to be applied to the image data among the plurality of detection modes to perform the image recognition processing.

Aspect 2 provides the imaging apparatus according to Aspect 1, wherein
the image data is moving image data including a plurality of frames sequentially captured by the image sensor at a predetermined frame period, and
the controller identifies the type of the subject in each frame, and switches the detection mode to be applied to the frame among the plurality of detection modes based on the identification result.

Aspect 3 provides the imaging apparatus according to Aspect 1 or 2, wherein
the image data is moving image data including a plurality of frames sequentially captured by the image sensor at a predetermined frame period, and
when a position of a subject of a specific type is detected in the image recognition processing in a detection mode applied to a specific frame based on the identification result of the type of the subject, the controller stops identifying the type of the subject in a frame subsequent to the specific frame and performs the image recognition processing using the detection mode same as that applied to the specific frame.

Aspect 4 provides the imaging apparatus according to Aspect 3, wherein
when, while the identification of the type of the subject is stopped, in the image recognition processing using the detection mode same as that applied to the specific frame, the position of the subject of the specific type corresponding to the detection mode is not detected for a predetermined period, the controller cancels the stop of the identification of the type of the subject, and switches the detection mode to be applied to the image data among the plurality of detection modes based on the identification result.

Aspect 5 provides the imaging apparatus according to any one of Aspects 1 to 4, further including a user interface that receives an input of a user operation that invalidates at least one of the plurality of detection modes, wherein
the controller excludes the at least one detection mode invalidated by the user operation from switching targets among the plurality of detection modes.

Aspect 6 provides the imaging apparatus according to any one of Aspects 1 to 5, further including a classifier that outputs, for each of a plurality of predetermined types of subjects, a probability that a subject of the type is included in the image, wherein
the controller identifies the type of the subject in the image based on the probability for each type output by the classifier, and switches the detection mode to be applied to the image data among the plurality of detection modes based on the identification result.

Aspect 7 provides the imaging apparatus according to Aspect 6, further including
a user interface that receives an input of a user operation that designates at least one type prioritized over other types among the plurality of types,
wherein when the probability of the at least one type is equal to or greater than a predetermined threshold, the controller switches the detection mode to be applied to the image data to a detection mode that detects a position of a subject of a type included in the at least one type, and
when the probability of the at least one type is less than the predetermined threshold, the controller switches the detection mode to be applied to the image data to a detection mode that detects a position of a subject of a type having the highest probability among the plurality of types.

Aspect 8 provides the imaging apparatus according to Aspect 7, wherein
the image data is moving image data including a plurality of frames sequentially captured by the image sensor at a predetermined frame period, and
when a position of a subject of a specific type is detected in the image recognition processing in a detection mode applied to a specific frame based on the identification result of the type of the subject and the detection mode is included in detection modes corresponding to the at least one type designated by the user operation, the controller stops identifying the type of the subject in a frame subsequent to the specific frame and performs the image recognition processing using the detection mode same as that applied to the specific frame.

Aspect 9 provides the imaging apparatus according to any one of Aspects 1 to 8, further including
an event sensor that detects a change in luminance of incident light, wherein
the controller identifies the type of the subject based on the change in the luminance detected by the event sensor, and switches the detection mode to be applied to the image data among the plurality of detection modes based on an identification result.

The present disclosure is applicable to various imaging apparatuses.

What is claimed is:

1. An imaging apparatus comprising:
an image sensor that captures a subject image to generate image data; and
a controller that has a plurality of detection modes to be applied to the image data generated by the image sensor, wherein
the plurality of detection modes respectively perform image recognition processing that detects positions of subjects of mutually different types in an image indicated by the image data, and wherein
the controller:
identifies a type of a subject in the image based on the image data; and
switches, based on an identification result, a detection mode to be applied to the image data among the plurality of detection modes to perform the image recognition processing.

2. The imaging apparatus according to claim 1, wherein
the image data is moving image data including a plurality of frames sequentially captured by the image sensor at a predetermined frame period, and
the controller identifies the type of the subject in each frame, and switches the detection mode to be applied to the frame among the plurality of detection modes based on the identification result.

3. The imaging apparatus according to claim 1, wherein
the image data is moving image data including a plurality of frames sequentially captured by the image sensor at a predetermined frame period, and
when a position of a subject of a specific type is detected in the image recognition processing in a detection mode applied to a specific frame based on the identification result of the type of the subject, the controller stops identifying the type of the subject in a frame subsequent to the specific frame and performs the image recognition processing using the detection mode same as that applied to the specific frame.

4. The imaging apparatus according to claim 3, wherein
when, while the identification of the type of the subject is stopped, in the image recognition processing using the detection mode same as that applied to the specific frame, the position of the subject of the specific type corresponding to the detection mode is not detected for a predetermined period, the controller cancels the stop of the identification of the type of the subject, and switches the detection mode to be applied to the image data among the plurality of detection modes based on the identification result.

5. The imaging apparatus according to claim 1, further comprising a user interface that receives an input of a user operation that invalidates at least one of the plurality of detection modes, wherein
the controller excludes the at least one detection mode invalidated by the user operation from switching targets among the plurality of detection modes.

6. The imaging apparatus according to claim 1, further comprising a classifier that outputs, for each of a plurality of predetermined types of subjects, a probability that a subject of the type is included in the image, wherein
the controller identifies the type of the subject in the image based on the probability for each type output by the classifier, and switches the detection mode to be applied to the image data among the plurality of detection modes based on the identification result.

7. The imaging apparatus according to claim 6, further comprising
a user interface that receives an input of a user operation that designates at least one type prioritized over other types among the plurality of types, wherein
when the probability of the at least one type is equal to or greater than a predetermined threshold, the controller switches the detection mode to be applied to the image data to a detection mode that detects a position of a subject of a type included in the at least one type, and
when the probability of the at least one type is less than the predetermined threshold, the controller switches the detection mode to be applied to the image data to a detection mode that detects a position of a subject of a type having the highest probability among the plurality of types.

8. The imaging apparatus according to claim 7, wherein
the image data is moving image data including a plurality of frames sequentially captured by the image sensor at a predetermined frame period, and
when a position of a subject of a specific type is detected in the image recognition processing in a detection mode applied to a specific frame based on the identification result of the type of the subject and the detection mode is included in detection modes corresponding to the at least one type designated by the user operation, the controller stops identifying the type of the subject in a frame subsequent to the specific frame and performs the image recognition processing using the detection mode same as that applied to the specific frame.

9. The imaging apparatus according to claim 1, further comprising
an event sensor that detects a change in luminance of incident light, wherein
the controller identifies the type of the subject based on the change in the luminance detected by the event sensor, and switches the detection mode to be applied to the image data among the plurality of detection modes based on an identification result.
